(19) United States
(12) Patent Application Publication
(10) Pub. No.: US 2017/0181382 A1
(43) Pub. Date: Jun. 29, 2017

(54) COMBINED PVC GARDENING PROFILE

(71) Applicant: WUHAN RUROFONTON TECHNOLOGY AND NEW MATERIAL CO., LTD., Wuhan, Hubei (CN)

(72) Inventors: Yunjie Bai, Wuhan, Hubei (CN); Jianxiong Wang, Wuhan, Hubei (CN)

(73) Assignee: WUHAN RUROFONTON TECHNOLOGY AND NEW MATERIAL CO., LTD., Wuhan, Hubei (CN)

(21) Appl. No.: 15/124,035

(22) PCT Filed: Jan. 5, 2016
(86) PCT No.: PCT/CN2016/070113

§ 371 Date: Sep. 7, 2016

(30) Foreign Application Priority Data
Jan. 30, 2015 (CN) 201510050053.9
Jan. 30, 2015 (CN) 201520068358.8

(51) Int. Cl. A01G 1/08; A01G 1/00

(52) U.S. Cl. CPC A01G 1/08; A01G 1/00

(57) ABSTRACT

A combined PVC gardening profile includes a main profile. The main profile includes a main-profile base board; a main-profile outer bottom frame is disposed on a left side of the main-profile base board; a main-profile invisible groove is disposed in the main-profile outer bottom frame; a main-profile invisible trench is disposed on a bottom surface of the main-profile invisible groove; a main-profile strengthening rib is disposed on a right side surface of the main-profile outer bottom frame; a main-profile cambered plate is connected to a top right corner of the main-profile outer bottom frame; a main-profile fluorescent lamp groove is disposed on the main-profile cambered plate; a main-profile inner side board is disposed at a lower end of a right end edge of the main-profile cambered plate; and several main-profile fastening pin holes are provided at a right edge of the main-profile base board.

### BACKGROUND

Technical Field

The present invention relates to a gardening profile, and more specifically, to a combined PVC gardening profile.

Related Art

Currently, palings in gardening generally use a cast iron structure, a brick-and-soil structure, or a timber structure, which must rely on professional workers to perform construction and installation. The cast iron structure is insecure, easy to rust, and has high costs, and palings that are of the brick-and-soil structure or the timber structure cannot be recycled but dismantled in a destructive manner, thereby causing unnecessary waste of resources.

### SUMMARY

An objective of the present invention is to provide a combined PVC gardening profile that is secure and environmentally friendly, and can be detached and combined repeatedly without relying on installation and construction by professionals.

It is implemented according to the following technical solution:

A combined PVC gardening profile is a PVC profile that can be detached and combined, including a main profile and a connecting piece, where

the main profile includes a main-profile base board; a main-profile outer bottom frame is disposed on a left side of the main-profile base board; a main-profile invisible groove is disposed in the main-profile outer bottom frame; a main-profile invisible trench is disposed on a bottom surface of the main-profile invisible groove; a main-profile strengthening rib is disposed on a right side surface of the main-profile outer bottom frame; a main-profile cambered plate is connected to a top right corner of the main-profile outer bottom frame; a main-profile fluorescent lamp groove is disposed on the main-profile cambered plate; a main-profile inner side board is disposed at a lower end of a right end edge of the main-profile cambered plate; and several main-profile fastening pin holes are further provided at a right end edge of the main-profile base board; and

the connecting piece includes a line-corner connecting piece, where the line-corner connecting piece includes an internal-corner-shaped line-corner connecting piece and an external-corner-shaped line-corner connecting piece, where

the internal-corner-shaped line-corner connecting piece includes a connecting-piece base board; a connecting-piece outer bottom frame is disposed on a left side of the connecting-piece base board; connecting-piece connecting tongues are disposed at two side edges of the connecting-piece outer bottom frame; a connecting-piece cambered plate is connected to a top right corner of the connecting-piece outer bottom frame; a connecting-piece fluorescent lamp groove is disposed on the connecting-piece cambered plate; a connecting-piece inner side board is disposed at a lower end of a right end edge of the connecting-piece cambered plate; the connecting-piece base board is connected to the connecting-piece cambered plate by using a connecting-piece supporting board; several connecting-piece fastening pin holes are further provided at a right end edge of the connecting-piece base board; and

the external-corner-shaped line-corner connecting piece includes a connecting-piece base board; a connecting-piece outer bottom frame is disposed on a left side of the connecting-piece base board; a connecting-piece cambered plate is connected to a top right corner of the connecting-piece outer bottom frame; a connecting-piece fluorescent lamp groove is disposed on the connecting-piece cambered plate; a connecting-piece inner side board is disposed at a lower end of a right end edge of the connecting-piece cambered plate; connecting-piece high-position connecting tongues are disposed at two end edges of the connecting-piece inner side board; the connecting-piece base board is connected to the connecting-piece cambered plate by using a connecting-piece supporting board; and several connecting-piece fastening pin holes are further provided at a right end edge of the connecting-piece base board.

All the main profiles are molded through extrusion, including a line-shaped main profile and an arc-shaped main profile, where the arc-shaped main profile includes an excurved arc-shaped main profile and an incurved arc-shaped main profile. A diameter of the arc-shaped main profile on the outmost periphery ranges from 1 m to 5 m; and a diameter of the arc-shaped main profile on the periphery is 1.5 m, 2.5 m, and 4.2 m.

The internal-corner-shaped line-corner connecting piece includes a 90° internal-corner-shaped line-corner connecting piece and a 135° internal-corner-shaped line-corner connecting piece; and

the external-corner-shaped line-corner connecting piece includes a 90° external-corner-shaped line-corner connecting piece and a 135° external-corner-shaped line-corner connecting piece.

The connecting piece further includes an arc corner connecting piece, where

the arc-corner connecting piece includes a connecting-piece base board; a connecting-piece outer bottom frame is disposed on a left side of the connecting piece base board; connecting-piece connecting tongues are disposed at two side edges of the connecting-piece outer bottom frame; a connecting-piece cambered plate is connected to a top right corner of the connecting-piece outer bottom frame; a connecting-piece fluorescent lamp groove is disposed on the connecting-piece cambered plate; a connecting-piece inner side board is disposed at a lower end of a right end edge of the connecting-piece cambered plate; and several connecting-piece fastening pin holes are further provided at a right end edge of the connecting piece base board.

The connecting piece further includes a line-shaped connecting piece, where the line-shaped connecting piece includes a connecting-piece base board; a connecting-piece outer bottom frame is disposed on a left side of the connecting-piece base board; connecting-piece connecting tongues are disposed at two side edges of the connecting-piece outer bottom frame; a connecting-piece cambered plate is connected to a top right corner of the connecting-piece outer bottom frame; a connecting-piece fluorescent lamp groove is disposed on the connecting-piece cambered plate; a connecting-piece inner side board is disposed at a lower end of a right end edge of the connecting-piece cambered plate; the connecting piece base board is connected to the connecting-piece cambered plate by using a connecting-piece supporting board; and several connecting-piece fastening pin holes are further provided at a right end edge of the connecting piece base board.

The combined PVC gardening profile further includes an end, where the end includes an end right side and an end left side, where

the end right side includes an end base board; an end outer bottom frame is disposed on a left side of the end base board; an end cambered plate is connected to a top right corner of the end outer bottom frame; an end fluorescent lamp groove is disposed on the end cambered plate; a right end edge of the end cambered plate is connected to the end base board by using an end inner side board; an end X-shaped strengthening rib is further connected to an inner side edge of the end outer bottom frame; end high-position connecting tongues are disposed at two end edges of an upper portion of the end inner side board; and several end fastening pin holes are provided on the end base board; and

the end left side is mirror-symmetrical to the end right side.

The combined PVC gardening profile further includes a supporting block, where

a supporting-block upper slot and a supporting-block lower slot are disposed on the supporting block; and

the supporting-block upper slot matches the main-profile inner side board in a concave-convex manner, and the supporting-block lower slot matches the main-profile strengthening rib in a concave-convex manner.

A right end of the main-profile base board exceeds a projection of a right end of the main-profile cambered plate in a horizontal direction; a right end of the connecting-piece base board exceeds a projection of a right end of the connecting-piece cambered plate in a horizontal direction; and a right end of the end base board exceeds a projection of a right end of the end cambered plate in a horizontal direction.

The combined PVC gardening profile further includes fastening pins, where the fastening pins fasten the combined PVC gardening profile on the ground by using the main-profile fastening pin holes, the connecting-piece fastening pin holes, and the end fastening pin holes.

The present invention has the following advantages: the present invention is a circular arc-shaped PVC profile product manufactured by utilizing extrusion production for the first time in the world. The product is a new product that replaces brick fences currently used in landscaping and that is developed for garden construction. The profile has an elegant appearance, facilitates to installation, saves labors and materials, and has a lower price than fences by using bricks at present. Processes of producing and using the circular arc-shaped PVC profile causes no environmental pollution and can be recycled to use.

### BRIEF DESCRIPTION OF THE DRAWINGS

FIG. 1 is a schematic structural diagram of a section of a main profile;

FIG. 2 is a top view of a 90° outer arc main profile;

FIG. 3 is a top view of a line-shaped main profile;

FIG. 4 is a top view of a 135° internal-corner-shaped connecting piece;

FIG. 5 is a longitudinal sectional view of a 135° internal-corner-shaped connecting piece;

FIG. 6 is a top view of a 135° external-corner-shaped connecting piece;

FIG. 7 is a longitudinal sectional view of a 135° external-corner-shaped connecting piece;

FIG. 8 is a top view of a 90° internal-corner-shaped connecting piece;

FIG. 9 is a longitudinal sectional view of a 90° internal-corner-shaped connecting piece;

FIG. 10 is a top view of a 90° external-corner-shaped connecting piece;

FIG. 11 is a longitudinal sectional view of a 90° external-corner-shaped connecting piece;

FIG. 12 is a longitudinal sectional view of a 90° arc connecting piece;

FIG. 13 is a top view of a 90° arc internal-corner-shaped connecting piece;

FIG. 14 is a top view of a 90° arc external-corner-shaped connecting piece;

FIG. 15 is a top view of a line-shaped connecting piece;

FIG. 16 is a longitudinal sectional view of a line-shaped connecting piece;

FIG. 17 is a top view of an end right side;

FIG. 18 is a left view of an end right side;

FIG. 19 is a top view of an end left side;

FIG. 20 is a right view of an end left side;

FIG. 21 is a schematic structural diagram of a supporting block;

FIG. 22 is a schematic diagram of a combined structure of a supporting-block main profile; and

FIG. 23 is a schematic structural diagram of a fastening pin.

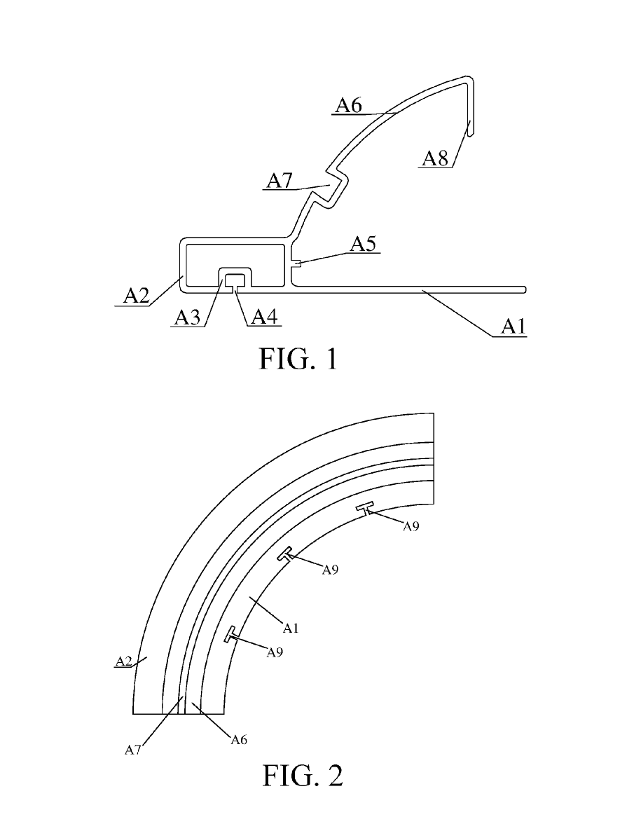

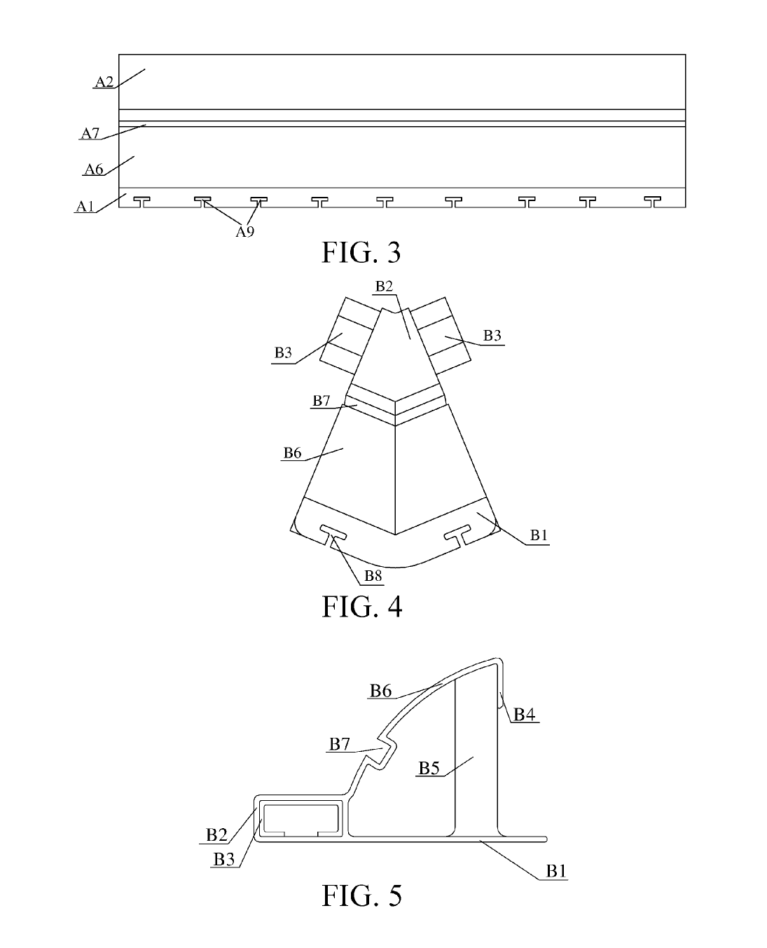

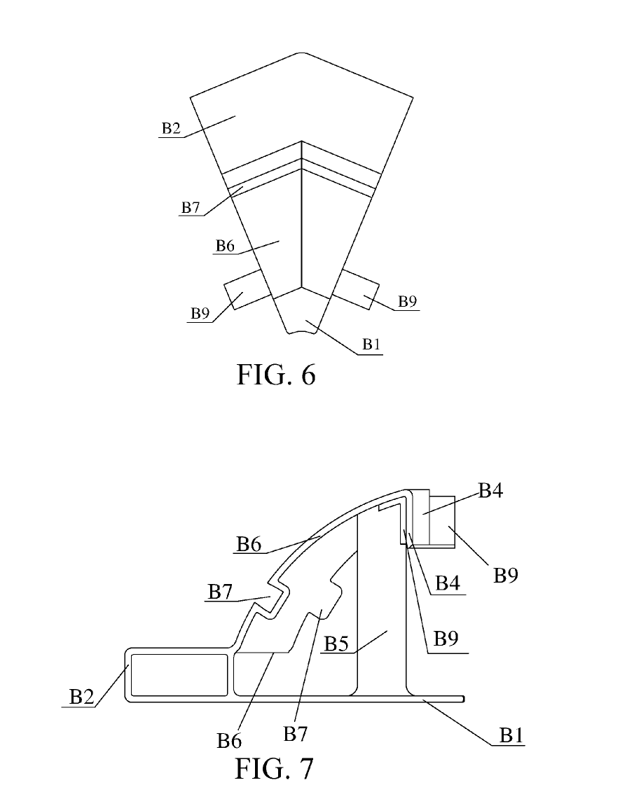

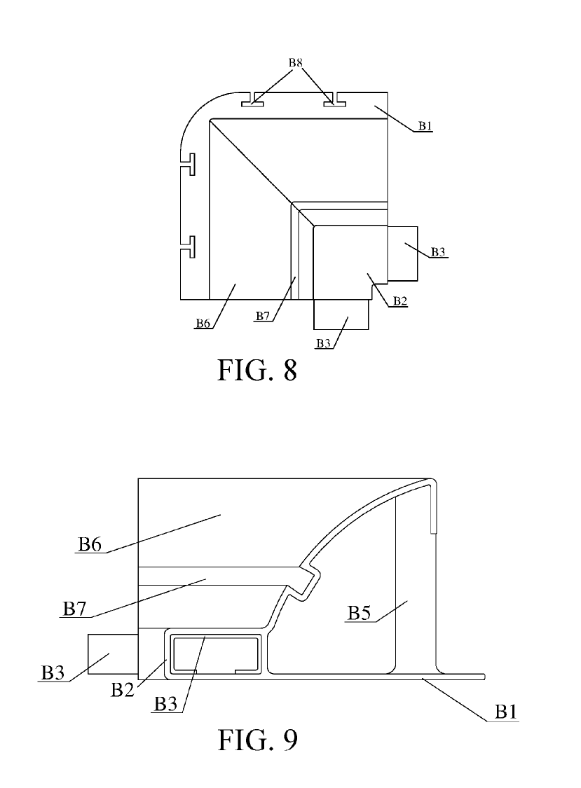

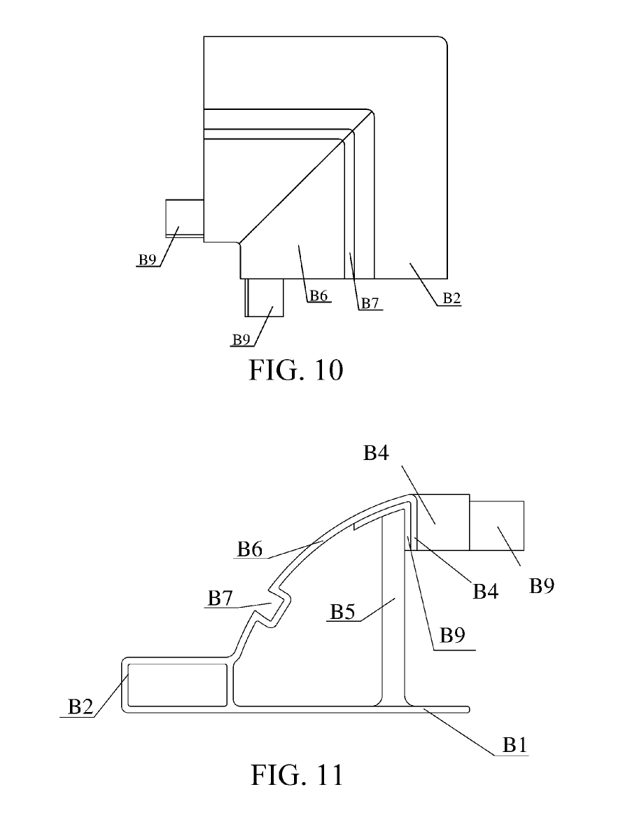

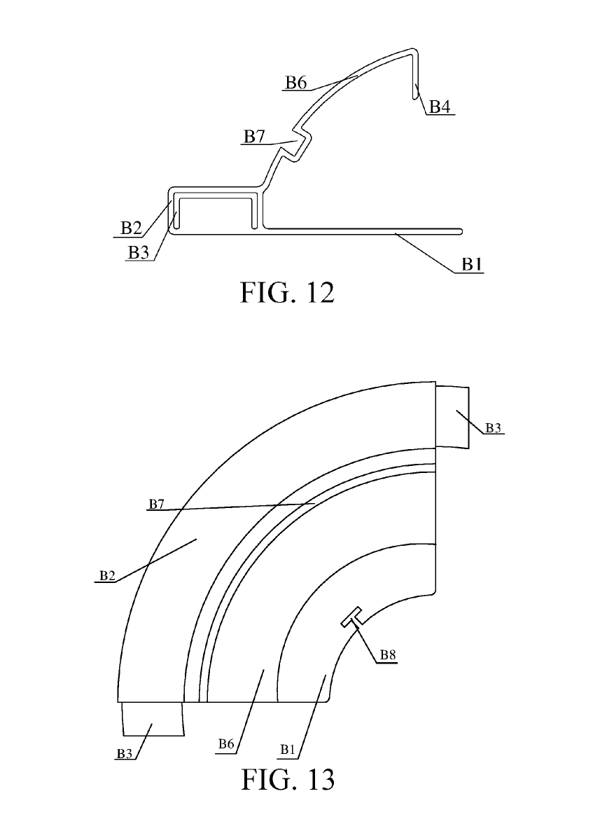

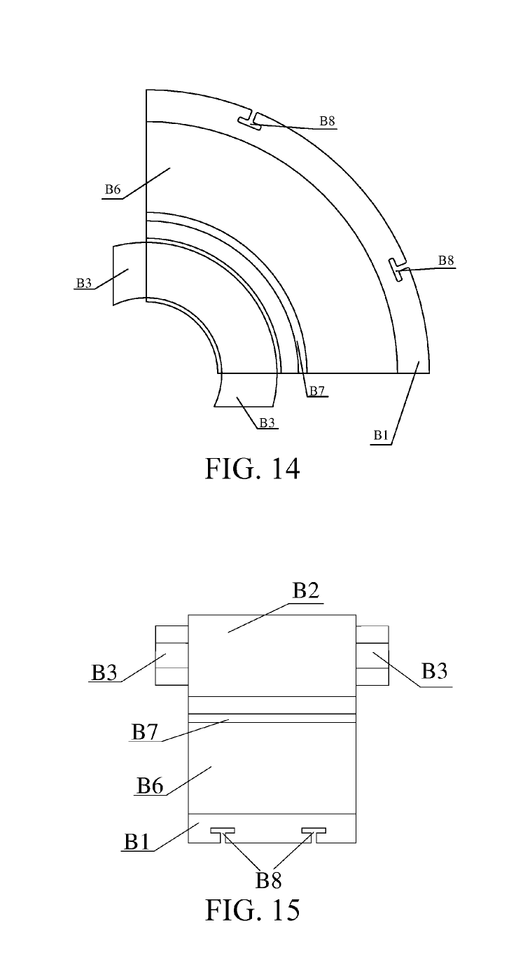

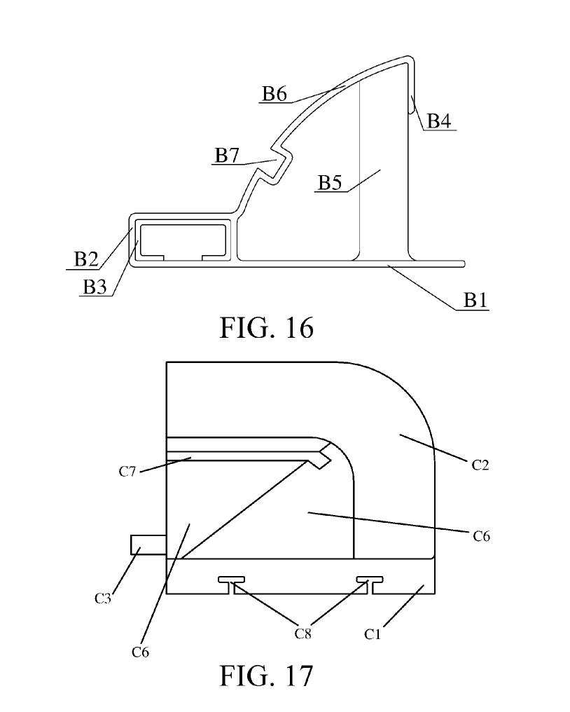

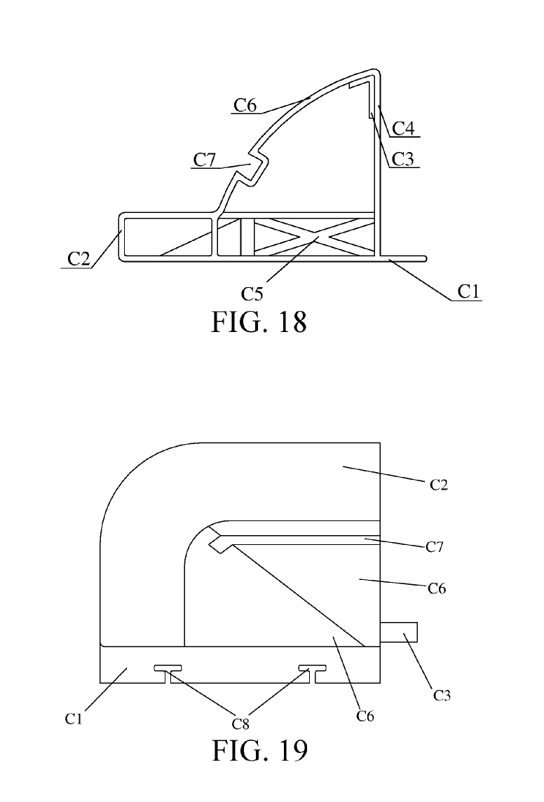

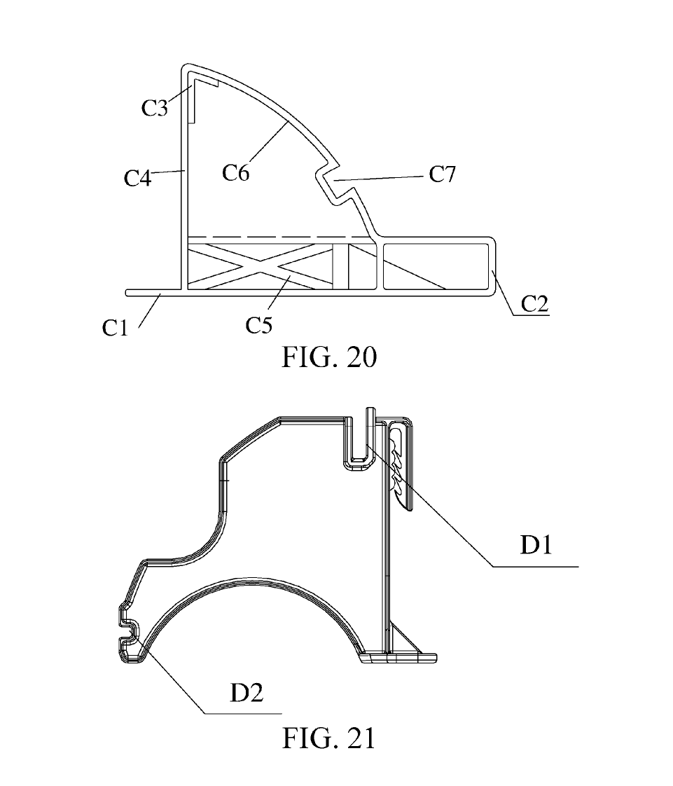

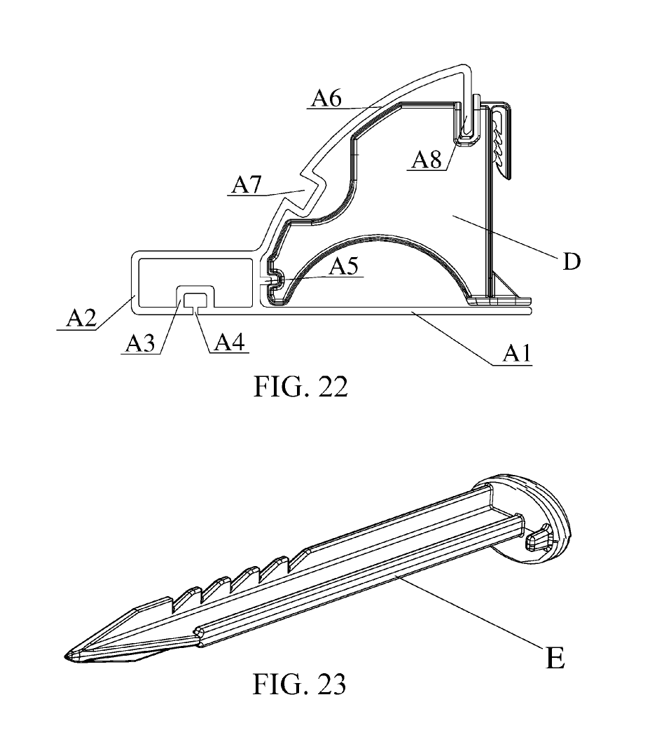

In the figures: main profile A; main-profile base board A1; main-profile outer bottom frame A2; main-profile invisible groove A3; main-profile invisible trench A4; main-profile strengthening rib A5; main-profile cambered plate A6; main-profile fluorescent lamp groove A7; main-profile inner side board A8; main-profile fastening pin hole A9; connecting piece B; connecting-piece base board B1; connecting-piece outer bottom frame B2; connecting-piece connecting tongue B3; connecting-piece inner side board B4; connecting-piece supporting board B5; connecting-piece cambered plate B6; connecting-piece fluorescent lamp groove B7; connecting-piece fastening pin hole B8; connecting-piece high-position connecting tongue B9; end C, end base board C1; end outer bottom frame C2; end high-position connecting tongues C3; end inner side board C4; end X-shaped strengthening rib C5; connecting-piece cambered plate C6; end fluorescent lamp groove C7; end fastening pin hole C8; supporting block D; supporting-block upper slot D1; supporting-block lower slot D2; and fastening pin E.

### DETAILED DESCRIPTION

The following further describes the present invention in detail with reference to the accompanying drawings and embodiments. It should be understood that the embodiments are not limit to the present invention but merely examples, and advantages of the present invention may be clearer and easy to understand with the descriptions.

As shown in the accompanying drawings, a combined PVC gardening profile is a PVC profile that can be detached and combined, including a main profile A and a connecting piece B, where

the main profile A includes a main-profile base board A1; a main-profile outer bottom frame A2 is disposed on a left side of the main-profile base board A1; a main-profile invisible groove A3 is disposed in the main-profile outer bottom frame A2; a main-profile invisible trench A4 is disposed on a bottom surface of the main-profile invisible groove A3; a main-profile strengthening rib A5 is disposed on a right side surface of the main-profile outer bottom frame A2; a main-profile cambered plate A6 is connected to a top right corner of the main-profile outer bottom frame A2; a main-profile fluorescent lamp groove A7 is disposed on the main-profile cambered plate A6; a main-profile inner side board A8 is disposed at a lower end of a right end edge of the main-profile cambered plate A6; and several main-profile fastening pin holes A9 are further provided at a right end edge of the main-profile base board A1; and

a cable, such as a wire, or a fluorescent lamp component can be installed on various fluorescent lamp grooves, a design of the invisible trench A4 can prevent a cable in the invisible groove A3 from corrosion by draining waters. The main-profile inner side board A8 enables a structure of the combined PVC gardening profile to be fuller and more elegant under the observation from multiple angles, and a height of a soil layer generally keeps between that of an upper end of the main-profile inner side board A8 and that of a lower end of the main-profile inner side board A8.

All the main profile A are molded through extrusion, including a line-shaped main profile and an arc-shaped main profile, where the arc-shaped main profile includes an excurved one and an incurved one. A diameter of the arc-shaped main profile on the outmost periphery ranges from 1 m to 5 m, and a diameter of the arc-shaped main profile on the periphery is 1.5 m, 2.5 m, and 4.2 m.

The connecting piece B includes a line-corner connecting piece, where the line-corner connecting piece includes an internal-corner-shaped line-corner connecting piece and an external-corner-shaped line-corner connecting piece, where

the internal-corner-shaped line-corner connecting piece includes a connecting-piece base board B1; a connecting-piece outer bottom frame B2 is disposed on a left side of the connecting-piece base board B1; connecting-piece connecting tongues B3 are disposed at two side edges of the connecting-piece outer bottom frame B2; a connecting-piece cambered plate B6 is connected to a top right corner of the connecting-piece outer bottom frame B2; a connecting-piece fluorescent lamp groove B7 is disposed on the connecting-piece cambered plate B6; a connecting-piece inner side board B4 is disposed at a lower end of a right end edge of the connecting-piece cambered plate B6; the connecting-piece base board B1 is connected to the connecting-piece cambered plate B6 by using a connecting-piece supporting board B5; several connecting-piece fastening pin holes B8 are further provided at a right end edge of the connecting-piece base board B1; and

the external-corner-shaped line-corner connecting piece includes a connecting-piece base board B1; a connecting-piece outer bottom frame B2 is disposed on a left side of the connecting-piece base board B1; a connecting-piece cambered plate B6 is connected to a top right corner of the connecting-piece outer bottom frame B2; a connecting-piece fluorescent lamp groove B7 is disposed on the connecting-piece cambered plate B6; a connecting-piece inner side board B4 is disposed at a lower end of a right end edge of the connecting-piece cambered plate B6; connecting-piece high-position connecting tongues B9 are disposed at two end edges of the connecting-piece inner side board B4; the connecting-piece base board B1 is connected to the connecting-piece cambered plate B6 by using a connecting-piece supporting board B5; and several connecting-piece fastening pin holes B8 are further provided at a right end edge of the connecting-piece base board B1.

The main profile A includes a line-shaped main profile and an arc-shaped main profile, where the arc-shaped main profile includes an excurved one and an incurved one.

The internal-corner-shaped line-corner connecting piece includes a 90° internal-corner-shaped line-corner connecting piece and a 135° internal-corner-shaped line-corner connecting piece; and

the external-corner-shaped line-corner connecting piece includes a 90° external-corner-shaped line-corner connecting piece and a 135° external-corner-shaped line-corner connecting piece.

The connecting piece B further includes an arc-corner connecting piece, where

the arc-corner connecting piece includes a connecting-piece base board B1; a connecting-piece outer bottom frame B2 is disposed on a left side of the connecting piece base board B1; connecting-piece connecting tongues B3 are disposed at two side edges of the connecting-piece outer bottom frame B2; a connecting-piece cambered plate B6 is connected to a top right corner of the connecting-piece outer bottom frame B2; a connecting-piece fluorescent lamp groove B7 is disposed on the connecting-piece cambered plate B6; a connecting-piece inner side board B4 is disposed at a lower end of a right end edge of the connecting-piece cambered plate B6; and several connecting-piece fastening pin holes B8 are further provided at a right end edge of the connecting piece base board B1.

The connecting piece B further includes a line-shaped connecting piece.

The line-shaped connecting piece includes a connecting-piece base board B1; a connecting-piece outer bottom frame B2 is disposed on a left side of the connecting-piece base board B1; connecting-piece connecting tongues B3 are disposed at two side edges of the connecting-piece outer bottom frame B2; a connecting-piece cambered plate B6 is connected to a top right corner of the connecting-piece outer bottom frame B2; a connecting-piece fluorescent lamp groove B7 is disposed on the connecting-piece cambered plate B6; a connecting-piece inner side board B4 is disposed at a lower end of a right end edge of the connecting-piece cambered plate B6; the connecting piece base board B1 is further connected to the connecting-piece cambered plate B6 by using a connecting-piece supporting board B5; and several connecting-piece fastening pin holes B8 are further provided at a right end edge of the connecting piece base board B1.

The combined PVC gardening profile further includes an end C, where

the end C includes an end right side and an end left side, where

the end right side includes an end base board C1; an end outer bottom frame C2 is disposed on a left side of the end base board C1; an end cambered plate C6 is connected to a top right corner of the end outer bottom frame C2; an end fluorescent lamp groove C7 is disposed on the end cambered plate C6; a right end edge of the end cambered plate C6 is connected to the end base board C1 by using an end inner side board C4; an end X-shaped strengthening rib C5 is further connected to an inner side edge of the end outer bottom frame C2; end high-position connecting tongues C3 are disposed at two end edges of an upper portion of the end inner side board C4; and several end fastening pin holes C8 are provided on the end base board C1; and

the end left side is mirror-symmetrical to the end right side.

The combined PVC gardening profile further includes a supporting block D, where

a supporting-block upper slot D1 and a supporting-block lower slot D2 are disposed on the supporting block D; and

the supporting-block upper slot D1 matches the main-profile inner side board A8 in a concave-convex manner, and the supporting-block lower slot D2 matches the main-profile strengthening rib A5 in a concave-convex manner. A design of the supporting block D ensures strength of the combined PVC gardening profile product when children or visitors play around a combined PVC gardening profile and treads on the combined PVC gardening profile.

A right end of the main-profile base board A1 exceeds a projection of a right end of the main-profile cambered plate A6 in a horizontal direction; a right end of the connecting-piece base board B1 exceeds a projection of a right end of the connecting-piece cambered plate B6 in a horizontal direction; and a right end of the end base board C1 exceeds a projection of a right end of the end cambered plate C6 in a horizontal direction.

The combined PVC gardening profile further includes fastening pins E, where

the fastening pins E fasten the combined PVC gardening profile on the ground by using the main-profile fastening pin holes A9, the connecting-piece fastening pin holes B8, and the end fastening pin holes C8. In this way, when the fastening pins E are installed, it is convenient for installers to stomp the fastening pins E into the earth because the fastening pin holes are specified to exceed edges of the cambered plates.

According to the present invention, the main profiles A are connected to one another by using various connecting pieces B, and are assembled into various shapes according to requirements. The outer bottom frame is outward and surrounds flowers and trees, and can be selected as any colors according to requirements.

It should be noted that the technical persons skilled in the art can make several changes or variations to the present invention on the premise that a principle of the present invention is not changed, and the changes and the variations all fall within the protection scope of the present invention.

What is claimed is:

1. A combined PVC gardening profile, wherein the combined PVC gardening profile is a PVC profile that can be detached and combined, comprising a main profile (A) and a connecting piece (B), wherein
the main profile (A) comprises a main-profile base board (A1); a main-profile outer bottom frame (A2) is disposed on a left side of the main-profile base board (A1); a main-profile invisible groove (A3) is disposed in the main-profile outer bottom frame (A2); a main-profile invisible trench (A4) is disposed on a bottom surface of the main-profile invisible groove (A3); a main-profile strengthening rib (A5) is disposed on a right side surface of the main-profile outer bottom frame (A2); a main-profile cambered plate (A6) is connected to a top right corner of the main-profile outer bottom frame (A2); a main-profile fluorescent lamp groove (A7) is disposed on the main-profile cambered plate (A6); a main-profile inner side board (A8) is disposed at a lower end of a right end edge of the main-profile cambered plate (A6); and several main-profile fastening pin holes (A9) are further provided at a right end edge of the main-profile base board (A1); and
the connecting piece (B) comprises a line-corner connecting piece, wherein the line-corner connecting piece comprises an internal-corner-shaped line-corner connecting piece and an external-corner-shaped line-corner connecting piece, wherein
the internal-corner-shaped line-corner connecting piece comprises a connecting-piece base board (B1); a connecting-piece outer bottom frame (B2) is disposed on a left side of the connecting-piece base board (B1); connecting-piece connecting tongues (B3) are disposed at two side edges of the connecting-piece outer bottom frame (B2); a connecting-piece cambered plate (B6) is connected to a top right corner of the connecting-piece outer bottom frame (B2); a connecting-piece fluorescent lamp groove (B7) is disposed on the connecting-piece cambered plate (B6); a connecting-piece inner side board (B4) is disposed at a lower end of a right end edge of the connecting-piece cambered plate (B6); the connecting-piece base board (B1) is connected to the connecting-piece cambered plate (B6) by using a connecting-piece supporting board (B5); several connecting-piece fastening pin holes (B8) are further provided at a right end edge of the connecting-piece base board (B1); and
the external-corner-shaped line-corner connecting piece comprises a connecting-piece base board (B1); a connecting-piece outer bottom frame (B2) is disposed on a left side of the connecting-piece base board (B1); a connecting-piece cambered plate (B6) is connected to a top right corner of the connecting-piece outer bottom frame (B2); a connecting-piece fluorescent lamp groove (B7) is disposed on the connecting-piece cambered plate (B6); a connecting-piece inner side board (B4) is disposed at a lower end of a right end edge of the connecting-piece cambered plate (B6); connecting-piece high-position connecting tongues (B9) are disposed at two end edges of the connecting-piece inner side board (B4); the connecting-piece base board (B1) is connected to the connecting-piece cambered plate (B6) by using a connecting-piece supporting board (B5); and several connecting-piece fastening pin holes (B8) are further provided at a right end edge of the connecting-piece base board (B1).

2. The combined PVC gardening profile according to claim 1, wherein
the main profile (A) comprises a line-shaped main profile and an arc-shaped main profile, wherein the arc-shaped main profile comprises an excurved arc-shaped main profile and an incurved arc-shaped main profile.

3. The combined PVC gardening profile according to claim 2, wherein
a diameter of the arc-shaped main profile on an outmost periphery ranges from 1 m to 5 m.

4. The combined PVC gardening profile according to claim 1, wherein
the internal-corner-shaped line-corner connecting piece comprises a 90° internal-corner-shaped line-corner connecting piece and a 135° internal-corner-shaped line-corner connecting piece; and
the external-corner-shaped line-corner connecting piece comprises a 90° external-corner-shaped line-corner connecting piece and a 135° external-corner-shaped line-corner connecting piece.

5. The combined PVC gardening profile according to claim 1, wherein
the connecting piece (B) further comprises an arc-corner connecting piece, wherein
the arc-corner connecting piece comprises a connecting-piece base board (B1); a connecting-piece outer bottom frame (B2) is disposed on a left side of the connecting piece base board (B1); connecting-piece connecting tongues (B3) are disposed at two side edges of the connecting-piece outer bottom frame (B2); a connecting-piece cambered plate (B6) is connected to a top right corner of the connecting-piece outer bottom frame (B2); a connecting-piece fluorescent lamp groove (B7) is disposed on the connecting-piece cambered plate (B6); a connecting-piece inner side board (B4) is disposed at a lower end of a right end edge of the connecting-piece cambered plate (B6); and several connecting-piece fastening pin holes (B8) are further provided at a right end edge of the connecting piece base board (B1).

6. The combined PVC gardening profile according to claim 1, wherein
the connecting piece (B) further comprises a line-shaped connecting piece, wherein
the line-shaped connecting piece comprises a connecting-piece base board (B1); a connecting-piece outer bottom frame (B2) is disposed on a left side of the connecting-piece base board (B1); connecting-piece connecting tongues (B3) are disposed at two side edges of the connecting-piece outer bottom frame (B2); a connecting-piece cambered plate (B6) is connected to a top right corner of the connecting-piece outer bottom frame (B2); a connecting-piece fluorescent lamp groove (B7) is disposed on the connecting-piece cambered plate (B6); a connecting-piece inner side board (B4) is disposed at a lower end of a right end edge of the connecting-piece cambered plate (B6); the connecting piece base board (B1) is further connected to the connecting-piece cambered plate (B6) by using a connecting-piece supporting board (B5); and several connecting-piece fastening pin holes (B8) are further provided at a right end edge of the connecting piece base board (B1).

7. The combined PVC gardening profile according to claim 1, further comprising an end (C), wherein
the end (C) comprises an end right side and an end left side, wherein
the end right side comprises an end base board (C1); an end outer bottom frame (C2) is disposed on a left side of the end base board (C1); an end cambered plate (C6) is connected to a top right corner of the end outer bottom frame (C2); an end fluorescent lamp groove (C7) is disposed on the end cambered plate (C6); a right end edge of the end cambered plate (C6) is connected to the end base board (C1) by using an end inner side board (C4); an end X-shaped strengthening rib (C5) is further connected to an inner side edge of the end outer bottom frame (C2); end high-position connecting tongues (C3) are disposed at two end edges of an upper portion of the end inner side board (C4); and several end fastening pin holes (C8) are provided on the end base board (C1); and
the end left side is mirror-symmetrical to the end right side.

8. The combined PVC gardening profile according to claim 1, further comprising a supporting block (D), wherein
a supporting-block upper slot (D1) and a supporting-block lower slot (D2) are disposed on the supporting block (D); and
the supporting-block upper slot (D1) matches the main-profile inner side board (A8) in a concave-convex manner, and the supporting-block lower slot (D2) matches the main-profile strengthening rib (A5) in a concave-convex manner.

9. The combined PVC gardening profile according to claim 7, wherein a right end of the main-profile base board (A1) exceeds a projection of a right end of the main-profile cambered plate (A6) in a horizontal direction; a right end of the connecting-piece base board (B1) exceeds a projection of a right end of the connecting-piece cambered plate (B6) in a horizontal direction; and a right end of the end base board (C1) exceeds a projection of a right end of the end cambered plate (C6) in a horizontal direction.

10. The combined PVC gardening profile according to claim 9, further comprising fastening pins (E), wherein
the fastening pins (E) fasten the combined PVC gardening profile on a ground by using the main-profile fastening pin holes (A9), the connecting-piece fastening pin holes (B8), and the end fastening pin holes (C8).
